(19) United States
(12) Patent Application Publication
(10) Pub. No.: US 2024/0073792 A1
(43) Pub. Date: Feb. 29, 2024

(54) TRANSMITTED BASIC SERVICE SET IDENTIFIER REASSIGNMENT

(71) Applicant: QUALCOMM Incorporated, San Diego, CA (US)

(72) Inventors: Abhishek Pramod PATIL, San Diego, CA (US); Gaurang NAIK, San Diego, CA (US); George CHERIAN, San Diego, CA (US); Alfred ASTERJADHI, San Diego, CA (US); Yanjun SUN, San Diego, CA (US); Abdel Karim AJAMI, Lakeside, CA (US); Sai Yiu Duncan HO, San Diego, CA (US)

(21) Appl. No.: 17/897,114

(22) Filed: Aug. 26, 2022

(51) Int. Cl. H04W 48/16; H04W 48/08

(52) U.S. Cl. CPC H04W 48/16; H04W 48/08

(57) ABSTRACT

Certain aspects of the present disclosure provide a method for wireless communications at an access point (AP) device, generally including generating a first frame that indicates updated roles associated with at least two basic service set IDs (BSSIDs) of a multi-BSSID set, wherein the updated roles relate to whether a BSSID is a transmitted BSSID (TxBSSID) or a nontransmitted BSSID (nonTxBSSID) and outputting the first frame for transmission.

### BACKGROUND

### Field of the Disclosure

Aspects of the present disclosure relate to wireless communications, and more particularly, to techniques for transmitted basic service set identifier (BSSID) reassignment.

### Description of Related Art

Wireless communications networks are widely deployed to provide various communications services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique for communications systems. MIMO technology has been adopted in several wireless communications standards such as the Institute of Electrical and Electronics Engineers (IEEE) 802.11 standard. The IEEE 802.11 denotes a set of Wireless Local Area Network (WLAN) air interface standards developed by the IEEE 802.11 committee for short-range communications (such as tens of meters to a few hundred meters).

### SUMMARY

One aspect provides a method for wireless communications at an access point (AP) device. The method includes generating a first frame that indicates updated roles associated with at least two basic service set IDs (BSSIDs) of a multi-BSSID set, wherein the updated roles relate to whether a BSSID is a transmitted BSSID (TxBSSID) or a nontransmitted BSSID (nonTxBSSID); and outputting the first frame for transmission.

Another aspect provides a method for wireless communications at a station. The method includes obtaining a first frame that indicates updated roles associated with at least two BSSIDs of a multi-BSSID set, wherein the updated roles relate to whether a BSSID is a TxBSSID or a nonTxBSSID; and monitoring for a second frame from an AP linked with a TxBSSID in accordance with the updated roles.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts a block diagram of an example multi-link device (MLD) deployment.

FIG. 4 depicts an example BBSID architecture.

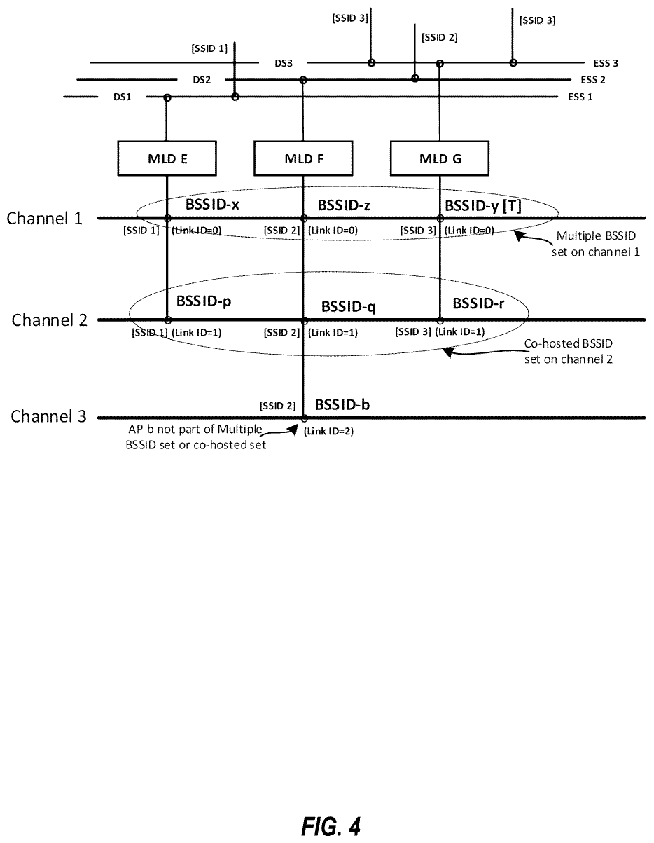

FIGS. 5A, 5B, and 5C depict an example of updated TxBSSID and nonTxBSSID roles, in accordance with aspects of the present disclosure.

FIGS. 6A and 6B depict an example of TxBSSID reassignment, in accordance with aspects of the present disclosure.

FIG. 7 depicts a method for wireless communications.

FIG. 8 depicts a method for wireless communications.

FIG. 9 depicts aspects of an example communications device.

FIG. 10 depicts aspects of an example communications device.

### DETAILED DESCRIPTION

Aspects of the present disclosure provide apparatuses, methods, processing systems, and computer-readable mediums for transmitted BSSID reassignment.

The concept of a Virtual Access Point (VAP) generally refers to the capability of a single physical AP to appear to be multiple APs. To wireless clients, each VAP appears to be a physical AP, despite the fact that the VAPs are actually operating within the same (i.e., single) physical AP. VAPs help vendors scale services, by relaxing the previous requirement of a one-to-one relationship between physical APs and wireless network security characteristics, such as authentication and encryption.

Multiple VAPs can exist within a single physical AP in compliance with standards (e.g., the IEEE 802.11 family of standards) for the Media Access Control (MAC) protocol layer that specify a unique Basic Service Set Identifier (BSSID) and Service Set identified (SSID). This operation allows for segmenting wireless network services within a single physical access point device. VAPs may be used, for example, to support multiple providers within public spaces such as airports.

One potential issue with VAPs is that multiple beacon frames could be needed, resulting in a large overhead (i.e., medium resources are consumed in transmitting several beacon frames leaving less time for useful data transmission). A beacon frame generally refers to one of the management frames in IEEE 802.11 based WLANs that contain information about the network. Beacon frames are typically transmitted periodically, at an AP's Target Beacon Transmission Time (TBTT), and serve to announce the presence of a wireless LAN, carry traffic announcement and provide time synchronization to the members of the service set.

To reduce the potential issue with air resource consumption of multiple VAPs, the concept of multiple BSSID (multi-BSSID or MBSSID) set was introduced, where each VAP may have its own BSSID. Multi-BSSID may reduce management frame overhead by requiring only one BSS in a multi-BSSID set to transmit beacon or respond to probe request frames (by transmitting probe response frames). The BSSID for the VAP that transmits a beacon or probe response is referred to as transmitted BSSID (TxBSSID). The BSSIDs for the rest of the VAPs that do not transmit beacons or probe response frames are referred to as nontransmitted BSSIDs (nonTxBSSIDs). The nonTxBSSIDs are advertised in the beacon and probe response frame of the TxBSSID, via one or more Multiple BSSID elements.

There are certain scenarios in which a TxBSSID needs to be disabled. For example, an extended basic service set (ESS) or SSID (and hence the service) corresponding to the TxBSSID may need to be turned OFF. As another example, multi-link operation (MLO) allows any AP of an AP multi-link (ML) device (MLD) to be removed (e.g., via a ML reconfiguration procedure) or disabled (e.g., via a Traffic ID (TID) to link mapping (T2LM) AP disablement).

The absence of TxBSSID presents a challenge in how to maintain operation of the MBSSID set, if the AP corresponding to TxBSSID is turned off, removed, or disabled. Without a TxBSSID, there may be no beacon or probe response transmitted by any of the remaining (nonTxBSSID) APs in the set. This means there may be no means for traffic announcement and unassociated STAs may not be able to discover any of the remaining APs, which could lead to a catastrophic collapse of the entire MBSSID set.

Aspects of the present disclosure, however, provide techniques that allow a new BSSID to assume the role of TxBSSID, in the event a current TxBSSID is turned off, removed, or disabled. By allowing TxBSSID/nonTxBSSID roles to be updated (reassigned), the techniques presented herein may serve as a graceful mechanism for the operations in the MBSSID set to continue and may help avoid catastrophic collapse of the entire MBSSID set.

### Introduction to Wireless Communications Networks

Various aspects of the disclosure are described more fully hereinafter with reference to the accompanying drawings. This disclosure may, however, be implemented in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be implemented by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The techniques described herein may be used for various broadband wireless communications systems, including communications systems that are based on an orthogonal multiplexing scheme. Examples of such communications systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (such as implemented within or performed by) a variety of wired or wireless apparatuses (such as nodes). In some aspects, a wireless node implemented in accordance with the teachings herein may comprise an access point or an access terminal.

An access point (“AP”) may comprise, be implemented as, or known as a Node B, Radio Network Controller (“RNC”), evolved Node B (eNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

An access terminal (“AT”) may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (such as a cellular phone or smart phone), a computer (such as a laptop), a tablet, a portable communications device, a portable computing device (such as a personal data assistant), an entertainment device (such as a music or video device, or a satellite radio), a global positioning system (GPS) device, or any other suitable device that is configured to communicate via a wireless or wired medium. In some aspects, the node is a wireless node. Such wireless node may provide, for example, connectivity for or to a network (such as a wide area network such as the Internet or a cellular network) via a wired or wireless communications link.

### Example Wireless Communications System

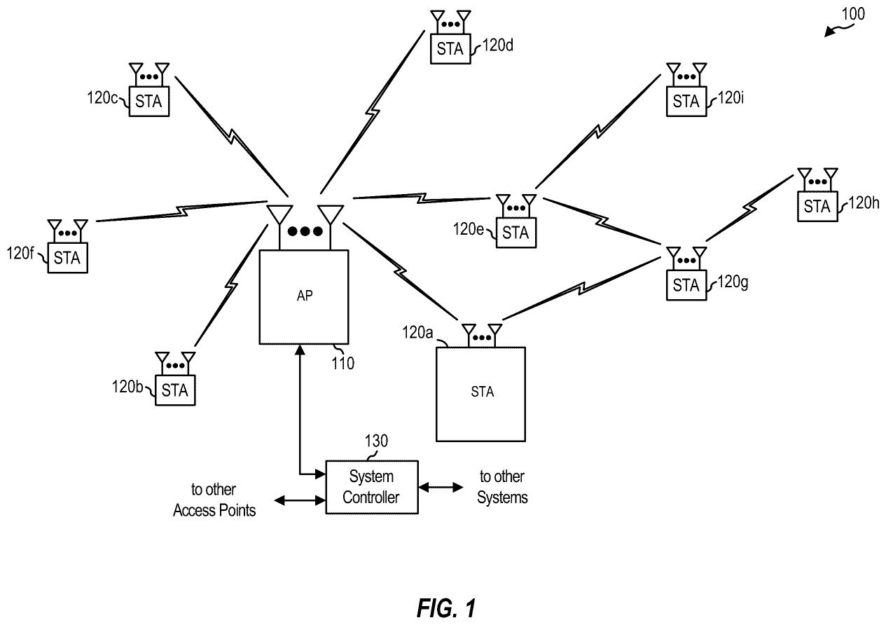

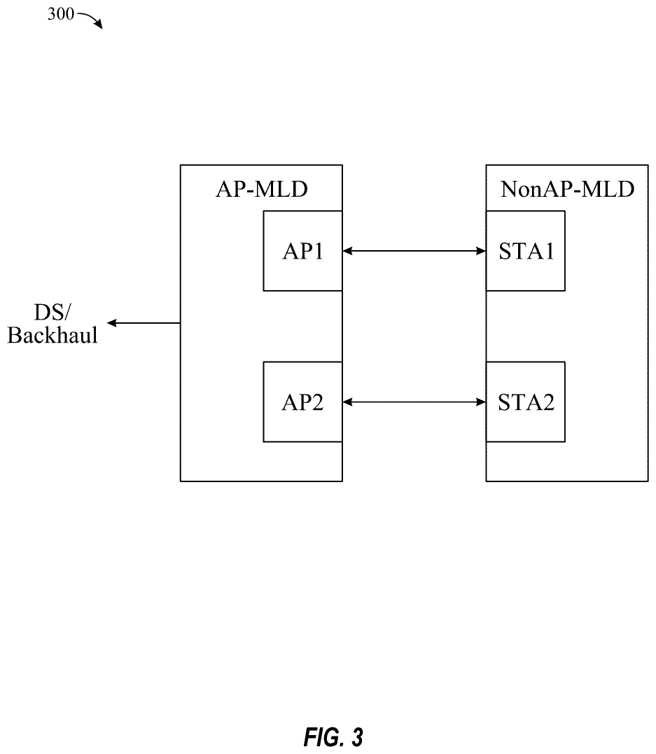

FIG. 1 is a diagram illustrating an example wireless communication system 100, in accordance with certain aspects of the present disclosure. System 100 may be a multiple-input multiple-output (MIMO)/multi-link operation (MLO) system 100. As shown in FIG. 1, an access point (AP) 110 includes an association manager 112 that may be configured to take one or more actions described herein. The wireless station (STA) 120a includes an association manager 122 that may be configured to take one or more actions described herein. In aspects, AP 110 and wireless station 120a may be MLDs as further described herein with respect to FIG. 3.

For simplicity, only one AP 110 is shown in FIG. 1. An AP is generally a fixed station that communicates with the wireless STAs and may also be referred to as a base station (B S) or some other terminology. A wireless STA may be fixed or mobile and may also be referred to as a mobile STA, a wireless device, or some other terminology. AP 110 may communicate with one or more wireless STAs 120 at any given moment on the downlink (DL) and/or uplink (UL). The DL (i.e., forward link) is the communication link from AP 110 to the wireless STAs 120, and the UL (i.e., reverse link) is the communication link from the wireless STAs 120 to AP 110. A wireless STA 120 may also communicate peer-to-peer with another wireless STA 120, for example, via a direct link such as a tunneled direct link setup (TDLS). A system controller 130 may be in communication with and provide coordination and control for the access points.

While portions of the following disclosure will describe wireless STAs 120 capable of communicating via Spatial Division Multiple Access (SDMA), for certain aspects, the wireless STAs 120 may also include some wireless STAs 120 that do not support SDMA. Thus, for such aspects, an AP 110 may be configured to communicate with both SDMA and non-SDMA wireless STAs 120. This approach may conveniently allow older versions of wireless STAs 120 (“legacy” stations) to remain deployed in an enterprise, extending their useful lifetime, while allowing newer SDMA wireless STAs 120 to be introduced as deemed appropriate.

System 100 employs multiple transmit and multiple receive antennas for data transmission on the DL and UL. AP 110 is equipped with Nₐₚ antennas and represents the multiple-input (MI) for DL transmissions and the multiple-output (MO) for UL transmissions. A set of K selected wireless stations 120 collectively represents the multiple-output for DL transmissions and the multiple-input for UL transmissions. For pure SDMA, it is desired to have Nₐₚ≥K≥1 if the data symbol streams for the K wireless STAs are not multiplexed in code, frequency or time by some means. K may be greater than Nₐₚ if the data symbol streams can be multiplexed using TDMA technique, different code channels with CDMA, disjoint sets of subbands with OFDM, and so on. Each selected wireless STA transmits user-specific data to and/or receives user-specific data from the access point. In general, each selected wireless STA may be equipped with one or multiple antennas (i.e., Nₛₜₐ≥1). The K selected wireless STAs can have the same or different number of antennas.

System 100 may be a time division duplex (TDD) system or a frequency division duplex (FDD) system. For a TDD system, the DL and UL share the same frequency band. For an FDD system, the DL and UL use different frequency bands. System 100 may also utilize a single carrier or multiple carriers for transmission. Each wireless STA may be equipped with a single antenna or multiple antennas. System 100 may also be a TDMA system if wireless STAs 120 share the same frequency channel by dividing transmission/reception into different time slots, each time slot being assigned to a different wireless STA 120.

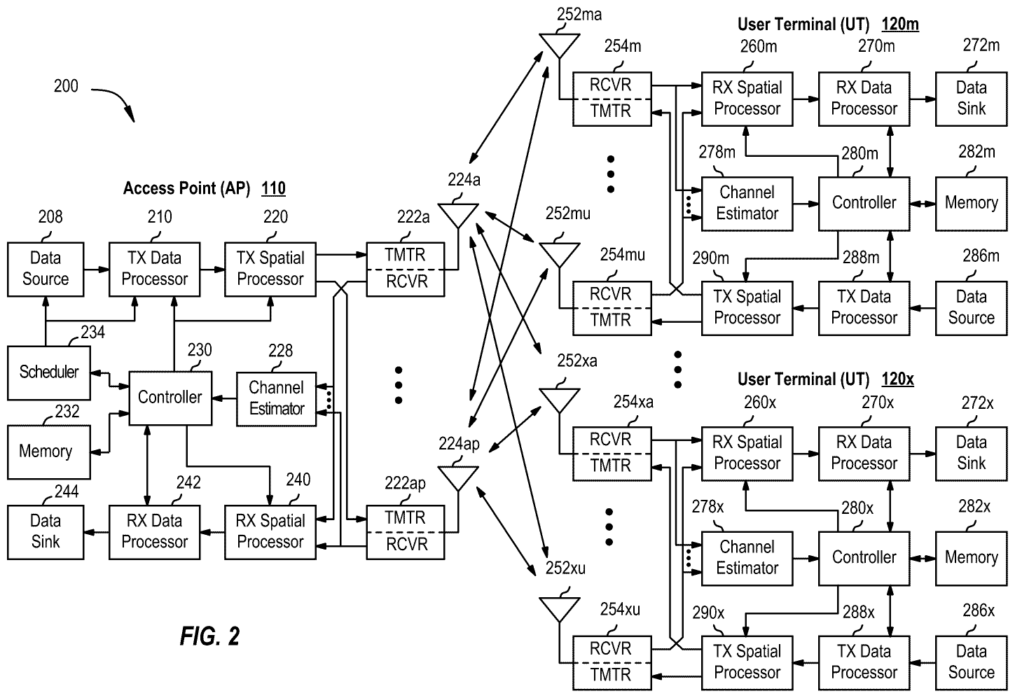

FIG. 2 illustrates a block diagram of AP 110 and two wireless STAs 120m and 120x in a MIMO/MLO system, such as system 100, in accordance with certain aspects of the present disclosure. In certain aspects, AP 110 and/or wireless STAs 120m and 120x may perform various techniques to ensure that a non-AP MLD is able to receive a group addressed frame. For example, AP 110 and/or wireless STAs 120m and 120x may include a respective association manager as described herein with respect to FIG. 1.

AP 110 is equipped with Nₐₚ antennas 224a through 224t. Wireless STA 120m is equipped with N_{sta,m} antennas 252ma through 252mu, and wireless STA 120x is equipped with N_{sta,x} antennas 252xa through 252xu. AP 110 is a transmitting entity for the DL and a receiving entity for the UL. Each wireless STA 120 is a transmitting entity for the UL and a receiving entity for the DL. As used herein, a “transmitting entity” is an independently operated apparatus or device capable of transmitting data via a wireless channel, and a “receiving entity” is an independently operated apparatus or device capable of receiving data via a wireless channel. The term communication generally refers to transmitting, receiving, or both. In the following description, the subscript “DL” denotes the downlink, the subscript “UL” denotes the uplink, N_{UL} wireless STAs are selected for simultaneous transmission on the uplink, N_{DL} wireless STAs are selected for simultaneous transmission on the downlink, N_{UL} may or may not be equal to N_{DL}, and N_{UL} and N_{DL} may be static values or can change for each scheduling interval. The beam-steering or some other spatial processing technique may be used at the access point and wireless station.

On the UL, at each wireless STA 120 selected for UL transmission, a transmit (TX) data processor 288 receives traffic data from a data source 286 and control data from a controller 280. TX data processor 288 processes (e.g., encodes, interleaves, and modulates) the traffic data for the wireless station based on the coding and modulation schemes associated with the rate selected for the wireless STA and provides a data symbol stream. A TX spatial processor 290 performs spatial processing on the data symbol stream and provides N_{sta,m} transmit symbol streams for the N_{sta,m} antennas. Each transceiver (TMTR) 254 receives and processes (e.g., converts to analog, amplifies, filters, and frequency upconverts) a respective transmit symbol stream to generate an uplink signal. N_{sta,m} transceivers 254 provide N_{sta,m} UL signals for transmission from N_{sta,m} antennas 252 to AP 110.

N_{UL} wireless STAs may be scheduled for simultaneous transmission on the uplink. Each of these wireless STAs performs spatial processing on its data symbol stream and transmits its set of transmit symbol streams on the UL to the AP 110.

At AP 110, Nₐₚ antennas 224a through 224ap receive the UL signals from all N_{UL} wireless STAs transmitting on the UL. Each antenna 224 provides a received signal to a respective transceiver (RCVR) 222. Each transceiver 222 performs processing complementary to that performed by transceiver 254 and provides a received symbol stream. A receive (RX) spatial processor 240 performs receiver spatial processing on the Nₐₚ received symbol streams from Nₐₚ transceiver 222 and provides N_{UL} recovered UL data symbol streams. The receiver spatial processing is performed in accordance with the channel correlation matrix inversion (CCMI), minimum mean square error (MMSE), soft interference cancellation (SIC), or some other technique. Each recovered UL data symbol stream is an estimate of a data symbol stream transmitted by a respective wireless station. An RX data processor 242 processes (e.g., demodulates, deinterleaves, and decodes) each recovered uplink data symbol stream in accordance with the rate used for that stream to obtain decoded data. The decoded data for each wireless STA may be provided to a data sink 244 for storage and/or a controller 230 for further processing.

On the DL, at AP 110, a TX data processor 210 receives traffic data from a data source 208 for N_{DL} wireless stations scheduled for downlink transmission, control data from a controller 230, and possibly other data from a scheduler 234. The various types of data may be sent on different transport channels. TX data processor 210 processes (e.g., encodes, interleaves, and modulates) the traffic data for each wireless station based on the rate selected for that wireless station. TX data processor 210 provides N_{DL} DL data symbol streams for the N_{DL} wireless stations. A TX spatial processor 220 performs spatial processing (such as a precoding or beamforming, as described in the present disclosure) on the N_{DL} DL data symbol streams, and provides Nₐₚ transmit symbol streams for the Nₐₚ antennas. Each transceiver 222 receives and processes a respective transmit symbol stream to generate a DL signal. Nₐₚ transceivers 222 providing Nₐₚ DL signals for transmission from Nₐₚ antennas 224 to the wireless STAs.

At each wireless STA 120, N_{sta,m} antennas 252 receive the Nₐₚ DL signals from access point 110. Each transceiver 254 processes a received signal from an associated antenna 252 and provides a received symbol stream. An RX spatial processor 260 performs receiver spatial processing on N_{sta,m} received symbol streams from N_{sta,m} transceiver 254 and provides a recovered DL data symbol stream for the wireless station. The receiver spatial processing is performed in accordance with the CCMI, MMSE or some other technique. An RX data processor 270 processes (e.g., demodulates, deinterleaves and decodes) the recovered DL data symbol stream to obtain decoded data for the wireless station.

At each wireless STA 120, a channel estimator 278 estimates the DL channel response and provides DL channel estimates, which may include channel gain estimates, SNR estimates, noise variance and so on. Similarly, a channel estimator 228 estimates the UL channel response and provides UL channel estimates. Controller 280 for each wireless STA typically derives the spatial filter matrix for the wireless station based on the downlink channel response matrix H_{dn,m} for that wireless station. Controller 230 derives the spatial filter matrix for the AP based on the effective UL channel response matrix H_{up,eff}. Controller 280 for each wireless STA may send feedback information (e.g., the downlink and/or uplink eigenvectors, eigenvalues, SNR estimates, and so on) to the AP. Controllers 230 and 280 also control the operation of various processing units at AP 110 and wireless STA 120, respectively.

### Overview of Multi-Link Devices

As initially described above, a multi-link device (MLD) generally refers to a single device or equipment that includes two or more station (STA) instances or entities, implemented in a physical (PHY)/medium access control (MAC) layer and configured to communicate on separate wireless links. In some examples, each MLD may include a single higher layer entity, such as a MAC Service Access Point (SAP) that may assign MAC protocol data units (MPDUs) for transmission by the separate STA instances.

FIG. 3 shows a block diagram of an example MLD deployment. As shown in FIG. 3, an access point (AP) MLD may communicate with a non-AP MLD. Each of the AP MLD and non-AP MLD may include at least two STA entities (hereinafter also referred to simply as “STAs”) that may communicate with associated STAs of another MLD. In an AP MLD, the STAs may be AP STAs (STAs serving as APs or simply “APs”). In a non-AP MLD, the STAs may be non-AP STAs (STAs not serving as APs). As also described above, MLDs may utilize multi-link aggregation (MLA) (which includes packet level aggregation), whereby MPDUs from a same traffic ID (TID) may be sent via two or more wireless links.

Various modes of communication may be employed in MLD implementations. For example, a MLD may communicate in an Asynchronous (Async) mode or a Synchronous (Sync) mode.

In the Async mode, a STA/AP may count down (for example, via a random backoff (RBO)) on both wireless links. A physical layer convergence protocol (PLCP) protocol data units (PPDU) start/end may happen independently on each of the wireless links. As a result, Async mode may potentially provide latency and aggregation gains. In certain cases, relatively complex (and costly) filters may be needed (for example, in the case of 5 GHz+6 GHz aggregation).

In the Sync mode, a STA/AP may also count down on both wireless links (e.g., assuming Link 1 and Link 2). If a first link (e.g., Link 1) wins the medium, both links may transmit PPDUs at the same time. Accordingly, this mode may need some restrictions to minimize in-device interference.

The Sync mode may work in 5 GHz+6 GHz aggregation and may require relatively low-filter performance, while still providing latency and aggregation gains. However, due to that STA's tiled architecture, this latency and aggregation gains may be hard to achieve.

Although not shown, a third mode of communication may include a Basic (for example, multi-primary with single link transmission) mode. In the Basic mode, a STA/AP may also count down on both wireless links. However, transmission may only occur on the wireless link that wins the medium. The other wireless link may be blocked by in-device interference greater than −62 decibels per milliwatt (dBm). No aggregation gains may be realized in this mode.

### Overview of Relationship Between MLO and MBSSID

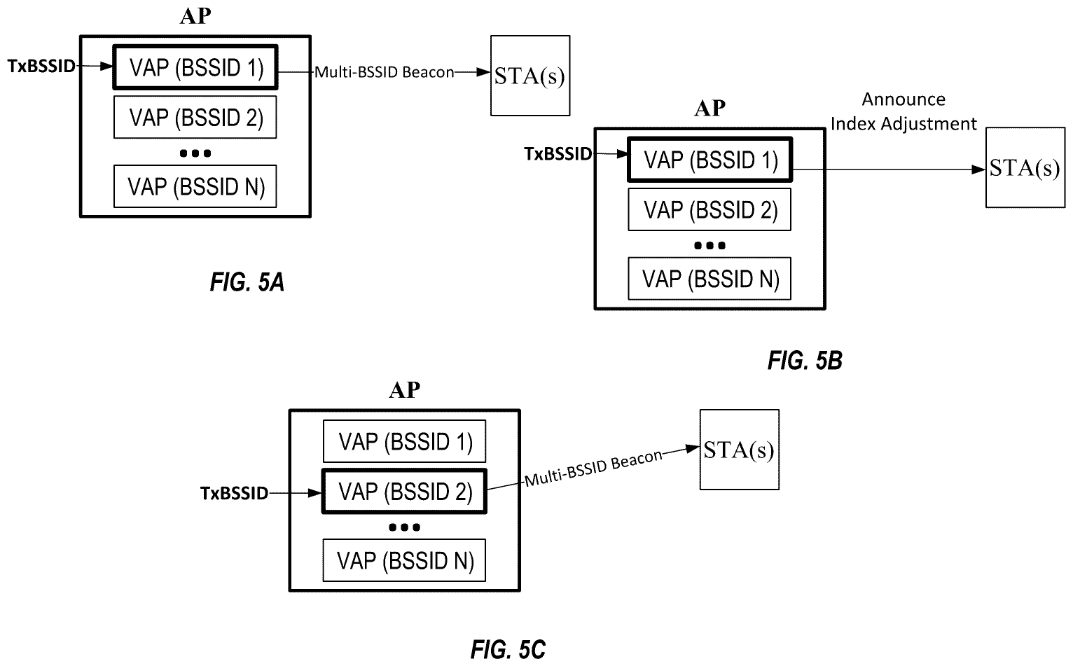

As illustrated in FIG. 5, in certain wireless systems, MLO and multi-BSSID (MBSSID) may co-exist. For example, the MBSSID concept may be implemented at a channel level while MLD goes across channels.

In such deployments, each AP affiliated with an AP MLD may be independently configured to operate as a transmitted or as a nontransmitted BSSID in a multiple BSSID set, or as an AP belonging to a co-hosted BSSID set, or as an AP that is neither a member of a multiple BSSID set nor a member of a co-hosted BSSID set.

In the example illustrated in FIG. 5, a Multiple BSSID set (BSSID-x, BSSID-y, and BSSID-z) is implemented on a first channel (channel 1), while a co-hosted BSSID set (BSSID-p, BSSID-q, and BSSID-r) is implemented on a second channel (channel 2). For the MBSSID set on channel 1, the AP for BSSID-y (APy) operates as the TxBSSID for the set.

In such deployments, an AP MLD can remove one or more of its affiliated APs by following an ML Reconfiguration procedure. An AP that is removed is essentially nonexistent, as no beacon or probe response frames are transmitted by such an AP. An AP MLD can also disable one or more of its affiliated APs by following a TID-to-Link mapping (T2LM) procedure. No frames may be transmitted on a disabled link, thus no beacon or probe response frames are transmitted by a disabled AP.

### Aspects Related to Transmitted BSSID Reassignment

Aspects of the present disclosure, however, provide techniques that allow a new BSSID to assume the role of TxBSSID, in the event a current TxBSSID is turned off, removed, or disabled. By allowing TxBSSID/nonTxBSSID roles to be updated (reassigned), the techniques presented herein may serve as a graceful mechanism for the operations in the MBSSID set to continue and may help avoid catastrophic collapse of the entire MBSSID set.

As noted above, multi-BSSID set may reduce management frame overhead by requiring only one BSS in a multi-BSSID set to transmit beacon or respond to probe request frames (by transmitting probe response frames). The BSSID for the VAP that transmits a beacon or probe response is referred to as transmitted BSSID (TxBSSID). The BSSIDs for the rest of the VAPs that do not transmit beacons or probe response frames are referred to as nontransmitted BSSIDs (nonTxBSSIDs). The nonTxBSSIDs are advertised in the beacon and probe response frame of the TxBSSID, via one or more Multiple BSSID elements.

All BSSs (BSSIDs) share the association ID (AID) space and the lowest AID value assigned to a station is 2ⁿ. The first 2ⁿ bits (i.e., 0 thru 2ⁿ−1) of the bitmap are reserved for the indication of group addressed frame for the TxBSSIDs and all nonTxBSSIDs. A traffic indication map (TIM) bitmap advertised in the Beacon of the TxBSSID signals buffered traffic for all associated STAs belonging to the MBBSID set. Each bit position in the traffic indication bitmap (referred to as Partial Virtual Bitmap field) in the TIM element matches the AID value assigned to a STA. Bits 0 thru 2ⁿ−1 indicate group address traffic for TxBSSID (bit 0) and for each nonTxBSSID in the set (1 thru 2ⁿ−1). For example, if the AP device has buffered traffic for STA1 (AID 77) which is associated with TxBSSID and STA2 (AID 23) that is associated with nonTxBSSID with index 3 and there is group address traffic for nonTxBSSIDs 5 and 7, then bit 5, 7, 23 and 77 will be set to 1 in the traffic indication bitmap carried in the TIM element which is included in the Beacon frame transmitted by the TxBSSID.

A maximum (Max) BSSID Indicator field carries the value n, where 2ⁿ is the maximum number of BSSIDs in the BSSID set. The BSSID(i) value corresponding to the i^{th} BSSID in the multiple BSSID set is derived from a reference BSSID (REF_BSSID) as follows:

BSSID(i)=BSSID_A|BSSID_B; where
BSSID_A is a BSSID with (48−n) MSBs equal to the (48−n) MSBs of the REF_BSSID and n LSBs equal to 0
BSSID_B is a BSSID with (48−n) MSBs equal to 0 and n LSBs equal to [(n LSBs of REF_BSSID)+i] mod 2ⁿ.
   The Reference BSSID may be the BSSID of the transmitting frame (e.g., Beacon or Probe Response frame).

There are various optional sub-elements that may carry profile information for each VAP. A VAP profile may consist of a set of elements (e.g., an SSID, Capabilities, etc.) required to define the operation of the BSS operated by the VAP. In general, elements having the same value as a transmitted BSSID may be inherited. Certain systems (e.g., 802.11ax) may make support for the Multiple BSSID feature mandatory for non-AP stations.

The MaxBSSID Indicator may provide an indication of the maximum (2ⁿ) BSSIDs that can be present in the set. The total number of active nonTxBSSIDs in the set at any given time can change and only a subset of nonTxBSSID may be active at any given time. In other words, standards may allow nonTxBSSIDs to be added or removed from an MBSSID set. However, the TxBSSID is conventionally always assumed to be active.

As noted above, however, there are certain scenarios in which a TxBSSID needs to be disabled. For example, an extended basic service set (ESS) or SSID (and hence the service) corresponding to the TxBSSID may need to be turned OFF. As another example, multi-link operation (MLO) allows any AP of an AP multi-link (ML) device (MLD) to be removed (e.g., via a ML reconfiguration procedure) or disabled (e.g., via T2LM AP disablement).

Aspects of the present disclosure, however, provide techniques that allow a new BSSID to assume the role of TxBSSID, in the event a current TxBSSID is turned off, removed, or disabled. By allowing TxBSSID/nonTxBSSID roles to be updated (reassigned), the techniques presented herein may serve as a graceful mechanism for the operations in the MBSSID set to continue and may help avoid catastrophic collapse of the entire MBSSID set.

The mechanisms described herein allow one of the nonTxBSSID takes on the role of TxBSSID after current TxBSSID is turned off, removed, or disabled. The proposed mechanisms may also apply for the case where the TxBSSID no longer wishes to operate in the role of TxBSSID, for example, if some other (AP corresponding to an) SSID is designated as TxBSSID. In such cases, the TxBSSID may relinquish its responsibilities and become a nonTxBSSID in the set.

Techniques for updating roles proposed herein may be understood with reference to the example shown in FIGS. 5A-5C. The illustrated example assumes an MBBSID set with BSSIDs 1-N (with corresponding N VAPs). Each VAP may have one or more stations (STAs) associated with it.

As illustrated in FIG. 5A, BSSID 1 is initially operating in the role of TxBSSID. Thus, only BSSID 1 transmits the beacon (and probe response frames). When a current TxBSSID is about to be decommissioned, it may transmit a frame to indicate (announce) updated roles. This announcement may be carried in the Beacon frame, a probe response frame, or a separate (new) frame.

For example, as illustrated in FIG. 5B, the current TxBSSID may transmit a frame that announces updated roles via an Index Adjustment. Because the TxBSSID is typically identified as the BSSID with BSSID index 0, a change to BSSID indexes may amount to a change in TxBSSID roles. In the illustrated example, as shown in FIG. 5C, after the Index Adjustment announcement BSSID 2 is the TxBSSID (e.g., its BSSID is 0 after the adjustment), while BSSID 0 may become a nonTxBSSID, may stop operating (i.e., is either disabled (AP disablement operation), or may be removed from the AP MLD (ML Reconfiguration operation) or is turned OFF).

In some cases, a switch count may also be announced with the Index Adjustment announcement. For example, the switch count may represent a countdown to the TBTT when the change in roles would occur (to be applied). For example, an old TxBSSID may shut down (e.g., immediately) after the beacon when the switch count has reached 0. The nonTxBSSID that has been designated as the new TxBSSID may take on the role after this beacon.

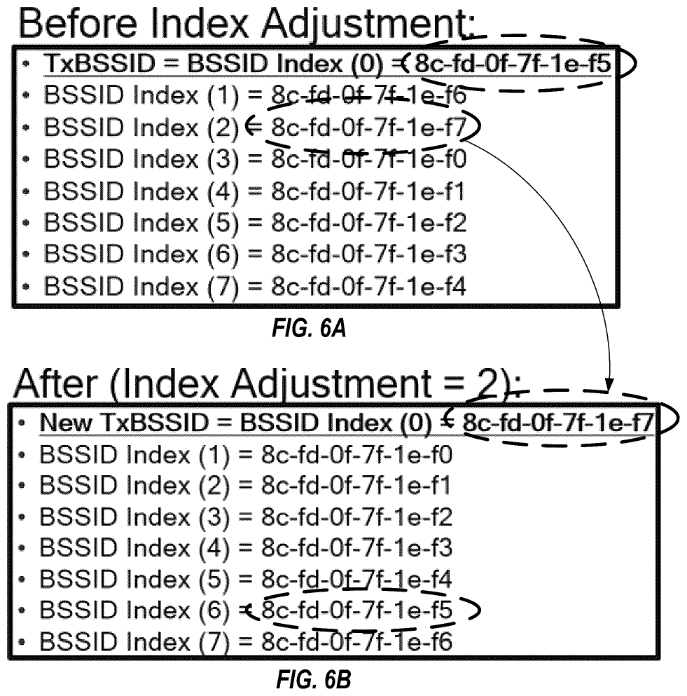

The example shown in FIGS. 6A and 6B illustrates how the index adjustment may be used to designate which BSSID will take on the TxBSSID role, based on current BSSID index values. Each VAP may update their BSSID indexes, based on the index adjustment (new index for all BSSID=current index−Index Adjustment).

In the illustrated example, the TxBSSID (the BSSID with index 0) in FIG. 6A is BSSID 8c-fd-0f-7f-1e-f5. Assuming an index adjustment of 2, the new TxBSSID in FIG. 6B (with index 0 after the Index adjustment), is the BSSID that had index 2 before the adjustment (BSSID 8c-fd-Of-7f-1e-f7), while the old TxBSSID becomes a nonTxBSSID (its previous index of 0 is updated to 6 after adjustment).

As shown in this example, since the MAC address of a nonTxBSSID is computed with reference to the MAC address of the TxBSSID, only the BSSID Index changes. In other words, there is no change to the MAC address of an AP in the MBSSID set. The updated index is also reflected by a change the bit positions in the traffic indication bitmap corresponding to each BSSID in the set (i.e., the bit position corresponding to the new index will indicate the group address traffic for each of the BSSIDs in the set).

In general, after the “switch” TBTT has passed (as indicated by the announced Switch Count), all the BSSIDs take on the new index value. Thus, all associated client devices (e.g., STAs illustrated in FIGS. 5A-5C) compute and start using the new BSSID Index for their associated AP.

In this manner, after a switch, STAs associated with an (old) nonTxBSSID maintain their association status and the original AID assigned to them. The new TxBSSID (BSSID whose computed/adjusted index=0) assumes the role of TxBSSID at next TBTT and at each TBTT that follows (transmitting beacons and responding to any probe request directed to any of the BSSIDs in the set). The mapping of the group address bitmap for each BSSID may be updated to reflect the new BSSID Index. In this manner, the stations may know how to interpret the TIM (knowing which bit corresponds to their BSSID).

In some cases, the Switch Count and Index Adjustment fields can be carried in a new element or an existing (extensible) element such as Multiple BSSID Configuration element. In this manner, certain stations (e.g., high efficiency (HE) STAs) may ignore the fields (as they are beyond the fields defined by standards (e.g., 802.11ax) they support. In some cases, STAs belonging to a newer amendment (e.g., extremely high throughput (EHT)) may parse the entire element and obtain this information.

This mechanism proposed herein may work for scenarios where the TxBSSID is turned off (e.g., can apply to single link case), deleted via an ML Reconfiguration AP Removal procedure, or disabled via T2LM AP Disablement procedure.

In some cases, for AP removal, the Index Adjustment field may be carried within a reconfiguration Multi-Link element. In this case, a Delete Timer subfield may be used to provide the countdown to the switch (when to apply the updated roles). For AP disablement, the Index Adjustment field may be carried within T2LM element or a reduced neighbor report (RNR) information element (IE) and the Mapping Switch Timer subfield in the T2LM element may provide the countdown to the switch. In both cases, a separate switch count field may not be needed.

ML reconfiguration procedure and T2LM AP disablement procedures may have provisions for disassociating legacy (e.g., HE) STAs. Therefore, the TxBSSID role switch procedure may be transparent to legacy STAs. Both such procedures may trigger critical updates procedure. Hence, EHT clients may be able to determine the upcoming change to the MBSSID configuration.

In some cases, if an MBSSID set includes only two BSSIDs (e.g., 1 TxBSSID and 1 nonTxBSSID), then after the role switch, the MBSSID set no longer exists and the nonTxBSSID starts beaconing as a single BSS AP.

There are various optional alternative mechanisms that could be used to address the TxBSSID role switch scenarios. For example, one option would be for the TxBSSID to accept no associations (this BSSID may be the only AP affiliated with an AP MLD). In this case, the sole purpose may be to beacon and respond to probes in order to keep the MBSSID set going. In some cases, the T2LM AP disablement procedure or ML Reconfiguration removal may not apply in such cases, since the TxBSSID it is the only AP of the AP MLD. Another option if a TxBSSID is being removed or disabled, is to require the same action (i.e., removal or disablement) to be applied to all BSSIDs in the set. For example, all associated pre-EHT STAs may be disassociated.

### Example Operations of an Access Point Device

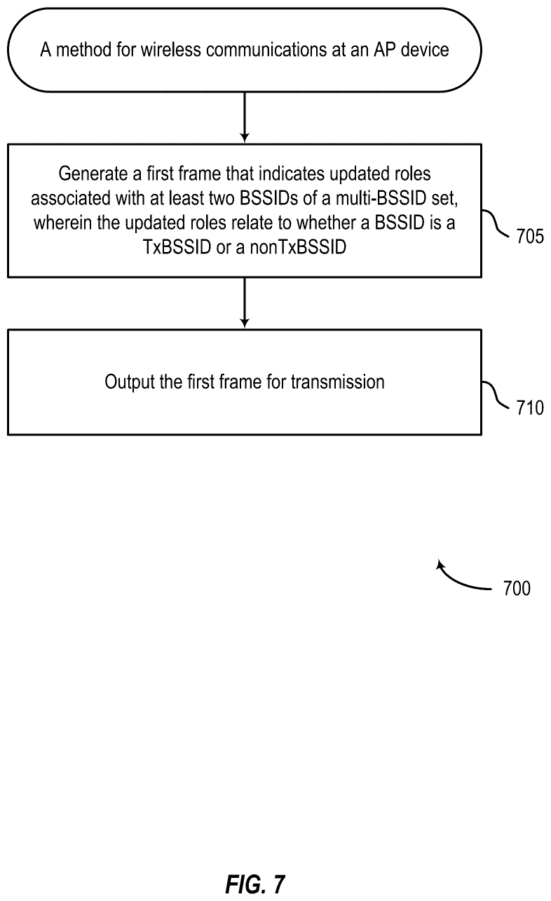

FIG. 7 shows an example of a method 700 for wireless communications at an AP device, such as an AP 110 of FIGS. 1 and 2.

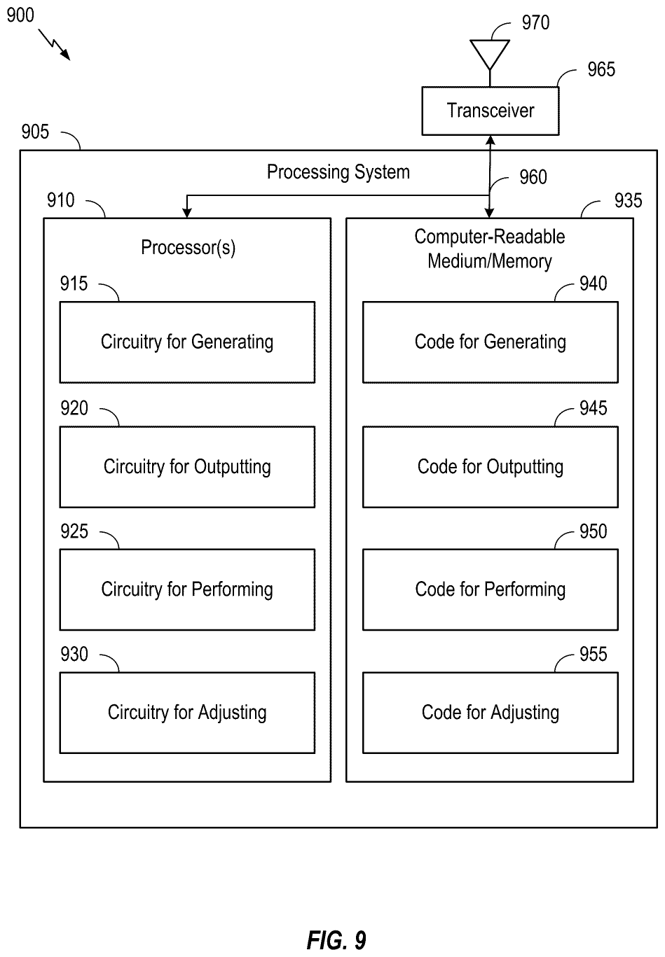

Method 700 begins at step 705 with generating a first frame that indicates updated roles associated with at least two BSSIDs of a multi-BSSID set, wherein the updated roles relate to whether a BSSID is a TxBSSID or a nonTxBSSID. In some cases, the operations of this step refer to, or may be performed by, circuitry for generating and/or code for generating as described with reference to FIG. 9.

Method 700 then proceeds to step 710 with outputting the first frame for transmission. In some cases, the operations of this step refer to, or may be performed by, circuitry for outputting and/or code for outputting as described with reference to FIG. 9.

In some aspects, each BSSID of the multi-BSSID set is linked with an AP.

In some aspects, each AP that is linked with a BSSID of the multi-BSSID set is a VAP affiliated with the AP device.

In some aspects, at least one of an AP linked with a TxBSSID or an AP linked with a nonTxBSSID is affiliated with an AP MLD.

In some aspects, the method 700 further includes performing one or more actions based on the updated roles. In some cases, the operations of this step refer to, or may be performed by, circuitry for performing and/or code for performing as described with reference to FIG. 9.

In some aspects, the one or more actions comprise: generating a second frame based on the updated roles; and outputting the second frame for transmission.

In some aspects, the second frame comprises at least one of a beacon frame or a probe response frame.

In some aspects, the first frame includes at least one of: a parameter that indicates the updated roles; or a counter that indicates when the updated roles apply.

In some aspects, the parameter indicates an index adjustment value for the at least two BSSIDs.

In some aspects, the method 700 further includes adjusting, based on the index adjustment value: an index value of a first BSSID, of the at least two BSSIDs, to indicate the updated role of the first BSSID to the role of TxBSSID; and an index value of a second BSSID, of the at least two BSSIDs, to indicate the updated role of the second BSSID to the role of nonTxBSSID. In some cases, the operations of this step refer to, or may be performed by, circuitry for adjusting and/or code for adjusting as described with reference to FIG. 9.

In some aspects, the method 700 further includes adjusting an index value of at least a third BSSID, of the multi-BSSID set, based on the index adjustment value. In some cases, the operations of this step refer to, or may be performed by, circuitry for adjusting and/or code for adjusting as described with reference to FIG. 9.

In some aspects, the parameter and the counter are conveyed in one or more elements of the first frame.

In some aspects, the parameter is conveyed in a reconfiguration multi-link element of the first frame or a RNR IE of the first frame; and the counter is conveyed in a delete timer subfield of the first frame.

In some aspects, the parameter is conveyed in a T2LM element of the first frame or a RNR IE of the first frame; and the counter is conveyed in a mapping switch timer subfield of the first frame.

In some aspects, the parameter and the counter are conveyed in a multiple BSSID configuration element of the first frame.

In one aspect, method 700, or any aspect related to it, may be performed by an apparatus, such as communications device 900 of FIG. 9, which includes various components operable, configured, or adapted to perform the method 700. Communications device 900 is described below in further detail.

Note that FIG. 7 is just one example of a method, and other methods including fewer, additional, or alternative steps are possible consistent with this disclosure.

### Example Operations of a Station

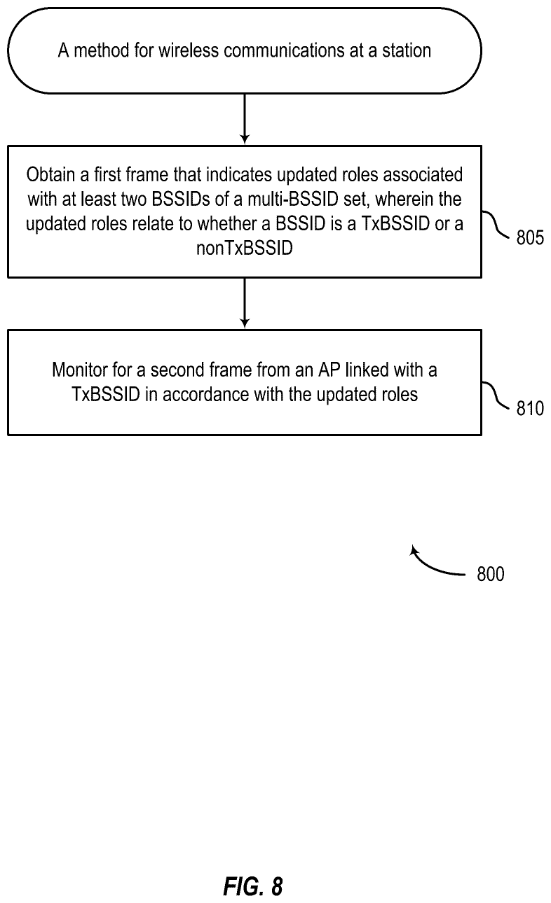

FIG. 8 shows an example of a method 800 for wireless communications at a station, such as a STA 120 of FIGS. 1 and 2.

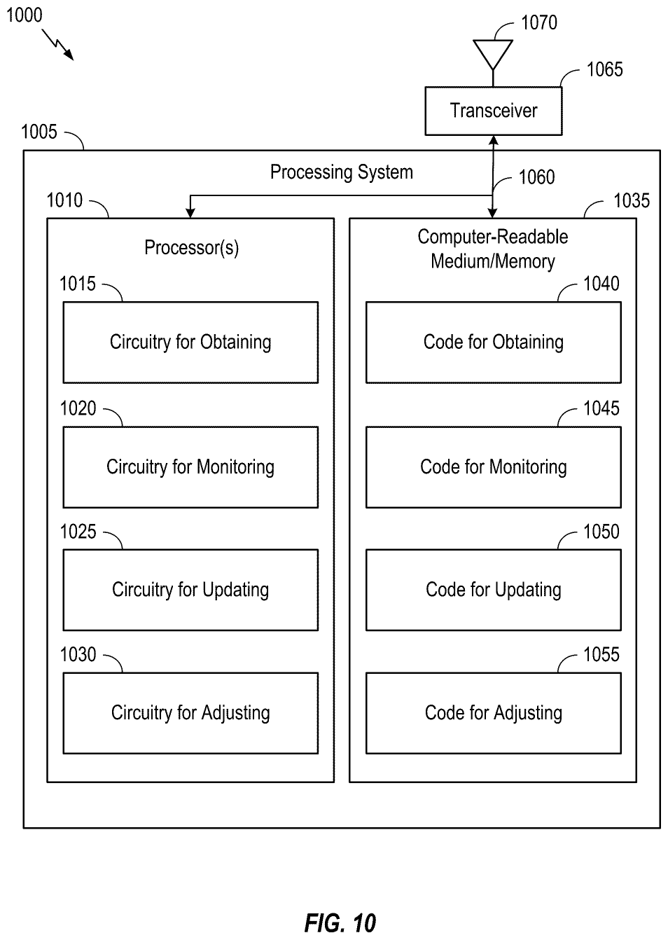

Method 800 begins at step 805 with obtaining a first frame that indicates updated roles associated with at least two BSSIDs of a multi-BSSID set, wherein the updated roles relate to whether a BSSID is a TxBSSID or a nonTxBSSID. In some cases, the operations of this step refer to, or may be performed by, circuitry for obtaining and/or code for obtaining as described with reference to FIG. 10.

Method 800 then proceeds to step 810 with monitoring for a second frame from an AP linked with a TxBSSID in accordance with the updated roles. In some cases, the operations of this step refer to, or may be performed by, circuitry for monitoring and/or code for monitoring as described with reference to FIG. 10.

In some aspects, each BSSID of the multi-BSSID set is linked with an AP.

In some aspects, each AP that is linked with a BSSID of the multi-BSSID set is a VAP affiliated with the AP device.

In some aspects, at least one of an AP linked with a TxBSSID or an AP linked with a nonTxBSSID is affiliated with an AP MLD.

In some aspects, the second frame comprises at least one of a beacon frame or a probe response frame.

In some aspects, the first frame includes at least one of: a parameter that indicates an index adjustment value; or a counter that indicates when the station is to apply the updated roles.

In some aspects, the method 800 further includes updating a BSSID index for a BSSID linked to an AP associated with the station, based on the index adjustment value. In some cases, the operations of this step refer to, or may be performed by, circuitry for updating and/or code for updating as described with reference to FIG. 10.

In some aspects, the method 800 further includes adjusting, based on the index adjustment value: an index value of a first BSSID, of the at least two BSSIDs, to indicate the updated role of the first BSSID to the role of TxBSSID; and an index value of a second BSSID, of the at least two BSSIDs, to indicate the updated role of the second BSSID to the role of nonTxBSSID. In some cases, the operations of this step refer to, or may be performed by, circuitry for adjusting and/or code for adjusting as described with reference to FIG. 10.

In some aspects, at least one of the first BSSID or the second BSSID has an AP that is associated with the station.

In some aspects, the method 800 further includes adjusting an index value of at least a third BSSID, of the multi-BSSID set, based on the index adjustment value. In some cases, the operations of this step refer to, or may be performed by, circuitry for adjusting and/or code for adjusting as described with reference to FIG. 10.

In some aspects, the third BSSID has an AP that is associated with the station.

In some aspects, the parameter and the counter are conveyed in a multiple BSSID configuration element of the first frame.

In some aspects, the parameter and the counter are obtained in one or more elements of the first frame.

In some aspects, the parameter is obtained in a reconfiguration multi-link element of the first frame or a RNR IE of the first frame; and the counter is obtained in a delete timer subfield of the first frame.

In some aspects, the parameter is obtained in a T2LM element of the first frame or a RNR IE of the first frame; and the counter is obtained in a mapping switch timer subfield of the first frame.

In one aspect, method 800, or any aspect related to it, may be performed by an apparatus, such as communications device 1000 of FIG. 10, which includes various components operable, configured, or adapted to perform the method 800. Communications device 1000 is described below in further detail.

Note that FIG. 8 is just one example of a method, and other methods including fewer, additional, or alternative steps are possible consistent with this disclosure.

### Example Communications Devices

FIG. 9 depicts aspects of an example communications device 900. In some aspects, communications device 900 is an AP, such as an AP 110 described above with respect to FIGS. 1 and 2.

The communications device 900 includes a processing system 905 coupled to the transceiver 965 (e.g., a transmitter and/or a receiver). The transceiver 965 is configured to transmit and receive signals for the communications device 900 via the antenna 970, such as the various signals as described herein. The transceiver 965 may be an example of aspects of transceiver 222 described with reference to FIG. 2. The processing system 905 may be configured to perform processing functions for the communications device 900, including processing signals received and/or to be transmitted by the communications device 900.

The processing system 905 includes one or more processors 910. In various aspects, the one or more processors 910 may be representative of one or more of the RX data processor 242, the TX data processor 210, the TX spatial processor 220, or the controller 230 of AP 110 illustrated in FIG. 2. The one or more processors 910 are coupled to a computer-readable medium/memory 935 via a bus 960. In certain aspects, the computer-readable medium/memory 935 is configured to store instructions (e.g., computer-executable code) that when executed by the one or more processors 910, cause the one or more processors 910 to perform the method 700 described with respect to FIG. 7, or any aspect related to it. Note that reference to a processor performing a function of communications device 900 may include one or more processors 910 performing that function of communications device 900.

In the depicted example, computer-readable medium/memory 935 stores code (e.g., executable instructions), such as code for generating 940, code for outputting 945, code for performing 950, and code for adjusting 955. Processing of the code for generating 940, code for outputting 945, code for performing 950, and code for adjusting 955 may cause the communications device 900 to perform the method 700 described with respect to FIG. 7, or any aspect related to it.

The one or more processors 910 include circuitry configured to implement (e.g., execute) the code stored in the computer-readable medium/memory 935, including circuitry such as circuitry for generating 915, circuitry for outputting 920, circuitry for performing 925, and circuitry for adjusting 930. Processing with circuitry for generating 915, circuitry for outputting 920, circuitry for performing 925, and circuitry for adjusting 930 may cause the communications device 900 to perform the method 700 described with respect to FIG. 7, or any aspect related to it.

Various components of the communications device 900 may provide means for performing the method 700 described with respect to FIG. 7, or any aspect related to it. For example, means for transmitting, sending or outputting for transmission may include the transmitter unit 222 or an antenna(s) 224 of AP 110 illustrated in FIG. 2 and/or the transceiver 965 and the antenna 970 of the communications device 900 in FIG. 9. In some aspects, means for receiving or obtaining may include the receiver unit 222 or an antenna(s) 224 of AP 110 illustrated in FIG. 2 and/or the transceiver 965 and the antenna 970 of the communications device 900 in FIG. 9.

FIG. 10 depicts aspects of an example communications device 1000. In some aspects, communications device 1000 is a station, such as a STA 120 described above with respect to FIGS. 1 and 2.

The communications device 1000 includes a processing system 1005 coupled to the transceiver 1065 (e.g., a transmitter and/or a receiver). The transceiver 1065 is configured to transmit and receive signals for the communications device 1000 via the antenna 1070, such as the various signals as described herein. The transceiver 1065 may be an example of aspects of transceiver 254 described with reference to FIG. 2. The processing system 1005 may be configured to perform processing functions for the communications device 1000, including processing signals received and/or to be transmitted by the communications device 1000.

The processing system 1005 includes one or more processors 1010. In various aspects, the one or more processors 1010 may be representative of the RX data processor 270, the TX data processor 288, the TX spatial processor 290, or the controller 280 of STA 120 illustrated in FIG. 2. The one or more processors 1010 are coupled to a computer-readable medium/memory 1035 via a bus 1060. In certain aspects, the computer-readable medium/memory 1035 is configured to store instructions (e.g., computer-executable code) that when executed by the one or more processors 1010, cause the one or more processors 1010 to perform the method 800 described with respect to FIG. 8, or any aspect related to it. Note that reference to a processor performing a function of communications device 1000 may include one or more processors 1010 performing that function of communications device 1000.

In the depicted example, computer-readable medium/memory 1035 stores code (e.g., executable instructions), such as code for obtaining 1040, code for monitoring 1045, code for updating 1050, and code for adjusting 1055. Processing of the code for obtaining 1040, code for monitoring 1045, code for updating 1050, and code for adjusting 1055 may cause the communications device 1000 to perform the method 800 described with respect to FIG. 8, or any aspect related to it.

The one or more processors 1010 include circuitry configured to implement (e.g., execute) the code stored in the computer-readable medium/memory 1035, including circuitry such as circuitry for obtaining 1015, circuitry for monitoring 1020, circuitry for updating 1025, and circuitry for adjusting 1030. Processing with circuitry for obtaining 1015, circuitry for monitoring 1020, circuitry for updating 1025, and circuitry for adjusting 1030 may cause the communications device 1000 to perform the method 800 described with respect to FIG. 8, or any aspect related to it.

Various components of the communications device 1000 may provide means for performing the method 800 described with respect to FIG. 8, or any aspect related to it. For example, in some cases, means for transmitting, sending or outputting for transmission may include the transmitter unit 254 or antenna(s) 252 of the STA 120 illustrated in FIG. 2 and/or the transceiver 1065 and the antenna 1070 of the communications device 1000 in FIG. 10. In some aspects, means for receiving or obtaining may include the receiver unit 254 or antenna(s) 252 of STA 120 illustrated in FIG. 2 and/or the transceiver 1065 and the antenna 1070 of the communications device 1000 in FIG. 10. In some aspects, means for generating, means for performing, means for adjusting, means for monitoring, and/or means for updating may include one or more of the processors illustrated in FIG. 2.

### Example Clauses

Implementation examples are described in the following numbered clauses:
Clause 1: A method for wireless communications at an AP device, comprising: generating a first frame that indicates updated roles associated with at least two BSSIDs of a multi-BSSID set, wherein the updated roles relate to whether a BSSID is a TxBSSID or a nonTxBSSID; and outputting the first frame for transmission.
Clause 2: The method of Clause 1, wherein each BSSID of the multi-BSSID set is linked with an AP.
Clause 3: The method of Clause 2, wherein each AP that is linked with a BSSID of the multi-BSSID set is a VAP affiliated with the AP device.
Clause 4: The method of any one of Clauses 1-3, wherein at least one of an AP linked with a TxBSSID or an AP linked with a nonTxBSSID is affiliated with an AP MLD.
Clause 5: The method of any one of Clauses 1-4, further comprising: performing one or more actions based on the updated roles.
Clause 6: The method of Clause 5, wherein the one or more actions comprise: generating a second frame based on the updated roles; and outputting the second frame for transmission.
Clause 7: The method of Clause 6, wherein the second frame comprises at least one of a beacon frame or a probe response frame.
Clause 8: The method of any one of Clauses 1-7, wherein the first frame includes at least one of: a parameter that indicates the updated roles; or a counter that indicates when the updated roles apply.
Clause 9: The method of Clause 8, wherein the parameter indicates an index adjustment value for the at least two BSSIDs.
Clause 10: The method of Clause 9, further comprising: adjusting, based on the index adjustment value: an index value of a first BSSID, of the at least two BSSIDs, to indicate the updated role of the first BSSID to the role of TxBSSID; and an index value of a second BSSID, of the at least two BSSIDs, to indicate the updated role of the second BSSID to the role of nonTxBSSID.
Clause 11: The method of Clause 10, further comprising: adjusting an index value of at least a third BSSID, of the multi-BSSID set, based on the index adjustment value.
Clause 12: The method of Clause 8, wherein the parameter and the counter are conveyed in one or more elements of the first frame.
Clause 13: The method of Clause 8, wherein: the parameter is conveyed in a reconfiguration multi-link element of the first frame or a RNR IE of the first frame; and the counter is conveyed in a delete timer subfield of the first frame.
Clause 14: The method of Clause 8, wherein: the parameter is conveyed in a T2LM element of the first frame or a RNR IE of the first frame; and the counter is conveyed in a mapping switch timer subfield of the first frame.
Clause 15: The method of Clause 8, wherein the parameter and the counter are conveyed in a multiple BSSID configuration element of the first frame.
Clause 16: A method for wireless communications at a station, comprising: obtaining a first frame that indicates updated roles associated with at least two BSSIDs of a multi-BSSID set, wherein the updated roles relate to whether a BSSID is a TxBSSID or a nonTxBSSID; and monitoring for a second frame from an AP linked with a TxBSSID in accordance with the updated roles.
Clause 17: The method of Clause 16, wherein each BSSID of the multi-BSSID set is linked with an AP.
Clause 18: The method of Clause 17, wherein each AP that is linked with a BSSID of the multi-BSSID set is a VAP affiliated with the AP device.
Clause 19: The method of Clause 17, wherein at least one of an AP linked with a TxBSSID or an AP linked with a nonTxBSSID is affiliated with an AP MLD.
Clause 20: The method of any one of Clauses 16-19, wherein the second frame comprises at least one of a beacon frame or a probe response frame.
Clause 21: The method of any one of Clauses 16-20, wherein the first frame includes at least one of: a parameter that indicates an index adjustment value; or a counter that indicates when the station is to apply the updated roles.
Clause 22: The method of Clause 21, further comprising: updating a BSSID index for a BSSID linked to an AP associated with the station, based on the index adjustment value.
Clause 23: The method of Clause 21, further comprising: adjusting, based on the index adjustment value: an index value of a first BSSID, of the at least two BSSIDs, to indicate the updated role of the first BSSID to the role of TxBSSID; and an index value of a second BSSID, of the at least two BSSIDs, to indicate the updated role of the second BSSID to the role of nonTxBSSID.
Clause 24: The method of Clause 23, wherein at least one of the first BSSID or the second BSSID has an AP that is associated with the station.
Clause 25: The method of Clause 23, further comprising: adjusting an index value of at least a third BSSID, of the multi-BSSID set, based on the index adjustment value.
Clause 26: The method of Clause 25, wherein the third BSSID has an AP that is associated with the station.
Clause 27: The method of Clause 23, wherein the parameter and the counter are conveyed in a multiple BSSID configuration element of the first frame.
Clause 28: The method of Clause 21, wherein the parameter and the counter are obtained in one or more elements of the first frame.
Clause 29: The method of Clause 21, wherein: the parameter is obtained in a reconfiguration multi-link element of the first frame or a RNR IE of the first frame; and the counter is obtained in a delete timer subfield of the first frame.
Clause 30: The method of Clause 21, wherein: the parameter is obtained in a T2LM element of the first frame or a RNR IE of the first frame; and the counter is obtained in a mapping switch timer subfield of the first frame.
Clause 31: An apparatus, comprising: a memory comprising executable instructions; and a processor configured to execute the executable instructions and cause the apparatus to perform a method in accordance with any one of Clauses 1-30.
Clause 32: An apparatus, comprising means for performing a method in accordance with any one of Clauses 1-30.
Clause 33: A non-transitory computer-readable medium comprising executable instructions that, when executed by a processor of an apparatus, cause the apparatus to perform a method in accordance with any one of Clauses 1-30.
Clause 34: A computer program product embodied on a computer-readable storage medium comprising code for performing a method in accordance with any one of Clauses 1-30.
Clause 35: An access point, comprising: at least one transceiver; a memory comprising instructions; and one or more processors configured to execute the instructions and cause the access point to perform a method in accordance with any one of Clauses 1-15, wherein the at least one transceiver is configured to transmit the first frame.
Clause 36: A station, comprising: at least one transceiver; a memory comprising instructions; and one or more processors configured to execute the instructions and cause the station to perform a method in accordance with any one of Clauses 16-30, wherein the at least one transceiver is configured to receive the first frame.
Clause 37: The method of Clause 9, further comprising: adjusting, based on the index adjustment value: bit positions in a traffic indication bitmap corresponding to each BSSID in the multi-BSSID set.
Clause 38: The method of Clause 21, further comprising: adjusting, based on the index adjustment value: at least one bit position, monitored by the station, in a traffic indication bitmap corresponding to at least one BSSID in the multi-BSSID set.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communications, comprising: a memory comprising processor-executable instructions; and one or more processors configured to execute the processor-executable instructions and cause the apparatus to:
generate a first frame that indicates updated roles associated with at least two basic service set IDs (BSSIDs) of a multi-BSSID set, wherein the updated roles relate to whether a BSSID is a transmitted BSSID (TxBSSID) or a nontransmitted BSSID (nonTxBSSID); and
output the first frame for transmission.

2. The apparatus of claim 1, wherein each BSSID of the multi-BSSID set is linked with an access point (AP).

3. The apparatus of claim 2, wherein each AP that is linked with a BSSID of the multi-BSSID set is a virtual AP (VAP) affiliated with the AP device.

4. The apparatus of claim 1, wherein at least one of an access point (AP) linked with a TxBSSID or an AP linked with a nonTxBSSID is affiliated with an AP multi-link device (MLD).

5. The apparatus of claim 1, wherein the one or more processors are configured to execute the processor-executable instructions and cause the apparatus to perform one or more actions based on the updated roles.

6. The apparatus of claim 5, wherein the one or more actions comprise:
generating a second frame based on the updated roles; and
outputting the second frame for transmission.

7. The apparatus of claim 6, wherein the second frame comprises at least one of a beacon frame or a probe response frame.

8. The apparatus of claim 1, wherein the first frame includes at least one of:
a parameter that indicates the updated roles; or
a counter that indicates when the updated roles apply.

9. The apparatus of claim 8, wherein the parameter indicates an index adjustment value for the at least two BSSIDs.

10. The apparatus of claim 9, wherein the one or more processors are configured to execute the processor-executable instructions and cause the apparatus to adjust, based on the index adjustment value:
an index value of a first BSSID, of the at least two BSSIDs, to indicate the updated role of the first BSSID to the role of TxBSSID; and
an index value of a second BSSID, of the at least two BSSIDs, to indicate the updated role of the second BSSID to the role of nonTxBSSID.

11. The apparatus of claim 10, wherein the one or more processors are configured to execute the processor-executable instructions and cause the apparatus to adjust an index value of at least a third BSSID, of the multi-BSSID set, based on the index adjustment value.

12. The apparatus of claim 8, wherein the parameter and the counter are conveyed in one or more elements of the first frame.

13. The apparatus of claim 8, wherein:
the parameter is conveyed in a reconfiguration multi-link element of the first frame or a reduced neighbor report (RNR) information element (IE) of the first frame; and
the counter is conveyed in a delete timer subfield of the first frame.

14. The apparatus of claim 8, wherein:
the parameter is conveyed in a Traffic ID (TID) to link mapping (T2LM) element of the first frame or a reduced neighbor report (RNR) information element (IE) of the first frame; and
the counter is conveyed in a mapping switch timer subfield of the first frame.

15. The apparatus of claim 1, further comprising at least one transceiver, wherein the at least one transceiver is configured to transmit the first frame and the apparatus is configured as an access point.

16. An apparatus for wireless communications, comprising: a memory comprising processor-executable instructions; and one or more processors configured to execute the processor-executable instructions and cause the apparatus to:
obtaining a first frame that indicates updated roles associated with at least two basic service set IDs (BSSIDs) of a multi-BSSID set, wherein the updated roles relate to whether a BSSID is a transmitted BSSID (TxBSSID) or a nontransmitted BSSID (nonTxBSSID); and
monitoring for a second frame from an access point (AP) linked with a TxBSSID in accordance with the updated roles.

17. The apparatus of claim 16, wherein each BSSID of the multi-BSSID set is linked with an AP.

18. The apparatus of claim 17, wherein each AP that is linked with a BSSID of the multi-BSSID set is a virtual AP (VAP) affiliated with the AP device.

19. The apparatus of claim 17, wherein at least one of an AP linked with a TxBSSID or an AP linked with a nonTxBSSID is affiliated with an AP multi-link device (MLD).

20. The apparatus of claim 16, wherein the second frame comprises at least one of a beacon frame or a probe response frame.

21. The apparatus of claim 16, wherein the first frame includes at least one of:
a parameter that indicates an index adjustment value; or
a counter that indicates when a station is to apply the updated roles.

22. The apparatus of claim 21, further comprising:
updating a BSSID index for a BSSID linked to an AP associated with the station, based on the index adjustment value.

23. The apparatus of claim 21, wherein the one or more processors are configured to execute the processor-executable instructions and cause the apparatus to adjust, based on the index adjustment value:
an index value of a first BSSID, of the at least two BSSIDs, to indicate the updated role of the first BSSID to the role of TxBSSID; and
an index value of a second BSSID, of the at least two BSSIDs, to indicate the updated role of the second BSSID to the role of nonTxBSSID.

24. The apparatus of claim 23, wherein at least one of the first BSSID or the second BSSID has an AP that is associated with the station.

25. The apparatus of claim 23, wherein the one or more processors are configured to execute the processor-executable instructions and cause the apparatus to adjust an index value of at least a third BSSID, of the multi-BSSID set, based on the index adjustment value.

26. The apparatus of claim 25, wherein the third BSSID has an AP that is associated with the station.

27. The apparatus of claim 21, wherein the parameter and the counter are obtained in one or more elements of the first frame.

28. The apparatus of claim 21, wherein:
the parameter is obtained in a reconfiguration multi-link element of the first frame or a reduced neighbor report (RNR) information element (IE) of the first frame; and
the counter is obtained in a delete timer subfield of the first frame.

29. The apparatus of claim 21, wherein:
the parameter is obtained in a Traffic ID (TID) to link mapping (T2LM) element of the first frame or a reduced neighbor report (RNR) information element (IE) of the first frame; and
the counter is obtained in a mapping switch timer subfield of the first frame.

30. A station comprising: at least one transceiver, a memory comprising processor-executable instructions; and one or more processors configured to execute the processor-executable instructions and cause the station to:
receive, via the transceiver, a first frame that indicates updated roles associated with at least two basic service set IDs (BSSIDs) of a multi-BSSID set, wherein the updated roles relate to whether a BSSID is a transmitted BSSID (TxBSSID) or a nontransmitted BSSID (nonTxBSSID); and
monitor for a second frame from an access point (AP) linked with a TxBSSID in accordance with the updated roles.
